(19) United States
(12) Patent Application Publication
(10) Pub. No.: US 2008/0259731 A1
(43) Pub. Date: Oct. 23, 2008

(54) Methods and apparatuses for user controlled beamforming

(76) Inventor: Aki P. Happonen, Kiiminki (FI)

Correspondence Address: Hollingsworth & Funk, LLC, Suite 125, 8009 34th Avenue South, Minneapolis, MN, 55425, US

(21) Appl. No.: 11/787,475

(22) Filed: Apr. 17, 2007

(51) Int. Cl. G10K 11/34

(52) U.S. Cl. 367/121

(57) ABSTRACT

A method for controlling beamforming in a device by a user of the device is provided. The method includes presenting current beam directional information via a user interface and receiving updated beam directional information in response to user input. The method also includes altering beamforming direction based upon the received updated beam directional information.

### FIELD OF THE INVENTION

This invention relates in general to improving the quality of received signals, and more particularly to methods and apparatuses for controlling the beamforming of multiple-transducer configurations.

### BACKGROUND OF THE INVENTION

In a world full of noise, most of which is unwanted sound, multiple-transducer (multiple-microphone) configurations are used to receive desired sound signals in a device. These configurations, when electronically directed or steered toward a sound's source, allow for focused reception of the desired sound. This reduces the reception of competing environmental sounds otherwise considered extraneous noise. The signal processing technique that effects this steering is beamforming.

Beamforming is used to improve the quality of a received signal by processing the signals received by an array of multiple transducers. Transducer array signal processing can be utilized to enhance the performance of the receiving system capturing the desired signal that has been emitted into a noisy environment. When receiving a signal, beamforming can increase the receiver sensitivity in the direction of wanted signals and decrease the sensitivity in the direction of interference and noise. Typical applications can be found in radio communications, radar signal processing, underwater acoustics, and speech acquisition for teleconferencing or interviewing and in hands-free systems.

The beam steering is accomplished by altering a signal's amplitude and phase shifts by changing beamforming filter coefficients. In a receiving device's beamformer the signal from each antenna may be amplified by a different “weight.” Different weighting patterns, for example, Dolph-Chebyshev, can be used to achieve the desired sensitivity patterns. A main lobe is produced together with nulls and sidelobes. As well as controlling the main lobe width (the beam) and the sidelobe levels, the position of a null can be controlled. This may be done to ignore noise in a particular direction, while receiving sound in other directions.

An adaptive beamformer uses a set of weightings and time-delays (or phasings) along with properties of received signals to adjust the filter coefficients of the beamformer. This process may be carried out in the time or frequency domains. An example of a system and method for adaptive beamforming may be found in U.S. Pat. No. 6,836,243 issued to Kajala et al., which is herein incorporated by reference.

To optimize reception of audio signals, beamforming is automatically steered by the processor of a device. The filter coefficients are calculated and applied without any involvement on the part of the device's user. However, these automatic adjustments cannot account for situations where a user desires to hear or receive sounds that are not in the direction toward which the device has steered.

Accordingly there is a need in the industry for, among other things, enabling a user to control the beamforming of a transducer array in a device so as to receive signals from a desired source when the device's beam is not currently steered toward the desired source. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses methods and apparatuses for controlling beamforming in a transducer array.

In accordance with one embodiment, a method is provided that involves presenting current beam directional information via a user interface, and receiving updated beam directional information in response to user input. The beamforming direction is altered based upon the received updated beam directional information.

According to more particular embodiments, the method may further involve providing a plurality of selectable modes for beam steering via the user interface device. Exemplary modes include, for example, an omni-directional receiving mode and a directional steering mode.

In accordance with another embodiment, an apparatus is provided that includes a plurality of microphones and a user input interface to facilitate user control of a direction of a beam of the plurality of microphones. The apparatus also includes a presentation module configured to present current and designated beam directional information of the plurality of microphones and a beamformer configured to change the direction of a beam of the plurality of microphones in response to input received from the user input interface.

According to particular embodiments, such an apparatus may be represented by a mobile device, and/or a personal digital assistant, portable computing device, video camera, etc. The presentation module may include anything capable of presenting information, such as, for example, a visual display(s), a speaker(s), a tactile response mechanism, etc. The user input interface may also include any manner of facilitating user entry of information, such as, for example, a keyboard, joystick, navigational tool, touch screen, switch, microphone, etc.

In accordance with another embodiment, an apparatus is provided that involves a module(s) for presenting current beam directional information via a user interface, and a module(s) for receiving updated beam directional information in response to user input. The apparatus further includes a module(s) for altering beamforming direction based upon the received updated beam directional information.

In accordance with another embodiment of the invention, computer-readable media is provided having instructions stored thereon that are executable by a processing system for controlling beamforming. This media's instructions can be executed by the processing system to perform various functions, including presenting current beam directional information via a user interface, receiving updated beam directional information in response to user input, and altering beamforming direction based upon the received updated beam directional information. In other example embodiments of the invention, the altering of beamforming direction includes adjusting filter coefficients of a beamformer.

In accordance with another embodiment of the invention, a system includes one or more audio sources, and a user-controllable beamforming device. The device includes a multiple microphone array, and a user input interface to facilitate user control of a direction of a beam of the multiple microphone array relative to one or more of the audio sources. A presentation module is configured to present current and designated beam directional information of the multiple microphone array. A beamformer is configured to change the direction of a beam of the multiple microphone array in response to input received from the user input interface.

The above summary of the invention is not intended to describe every embodiment or implementation of the present invention. Rather, attention is directed to the following figures and description which sets forth representative embodiments of the invention.

### BRIEF DESCRIPTION OF THE DRAWINGS

The invention is described in connection with the embodiments illustrated in the following diagrams.

FIG. 1 is a block diagram generally illustrating an apparatus in accordance with an embodiment of the invention;

FIG. 2A is a flow diagram illustrating one embodiment of a method for controlling the beamforming of a transducer array in accordance with the present invention;

FIG. 2B is a flow diagram illustrating an exemplary embodiment of a method for controlling the beamforming of a transducer array in accordance with the present invention;

FIGS. 3A-C illustrate example displays of a user interface in accordance with the present invention; and

FIG. 4 illustrates a representative example of a mobile device which may include a user interface in accordance with the present invention.

### DETAILED DESCRIPTION OF EMBODIMENTS OF THE INVENTION

In the following description of exemplary embodiments, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

Generally, the present invention is directed to apparatuses and methods for a user to control the beamforming of multiple microphones in a device. The device, such as a mobile telephone, optionally displays current beamforming information such as the direction and shape of the beam under the current configuration. The device's user may optionally input different beamforming information such as a new direction for the beam to be aimed. Both the current and input information may be presented to the user via a user interface connected to the device. In response to the user-inputted beamforming information, the device alters the direction of the beam to steer the beam in the direction designated by the user. Thus, the user manually controls the beam of the multiple microphone array of the device to receive signals from a selected audio source.

It is understood that signal sources and receivers are interchangeable. By changing the direction of the signal flow and replacing receiving transducers with transmitting transducers a corresponding signal can be emitted from the transducer array. While the following discussion refers to microphones as receiving transducers, the invention is applicable to user control of both receiving and transmitting transducers.

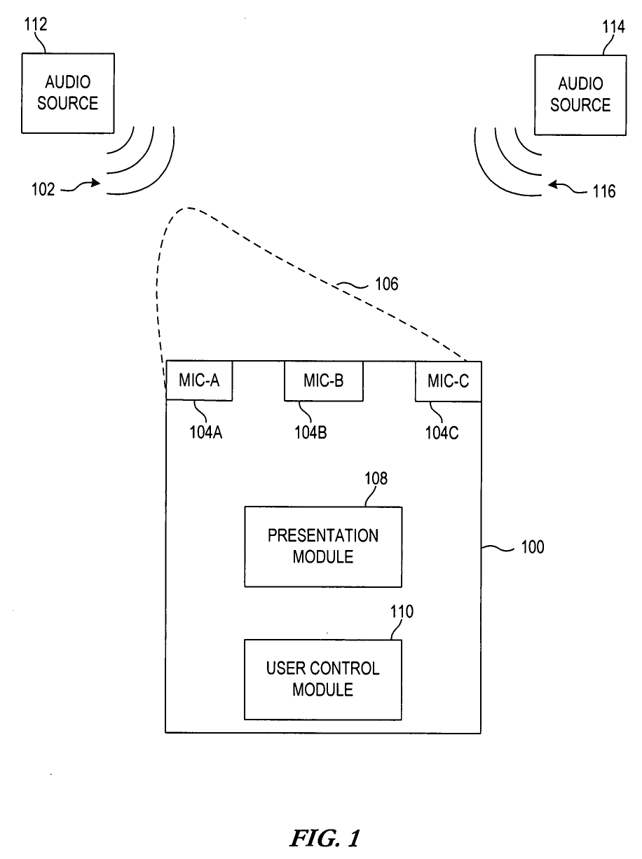

FIG. 1 is a block diagram generally illustrating an embodiment where a device 100 having a multiple microphone array 104A-C that may be controlled by the device user. The device 100 can be any type of device capable of receiving audio signals 102, such as, for example, a mobile phone, portable computing device, desktop computing device, personal digital assistant (PDA), camcorder or other video recording device, or other device capable of receiving audio signals and communicating information. The device 100 also includes a microphone array 104A-C. The number of microphones in the array is not limited, however, for example purposes only, the device 100 illustrates an array with three microphones 104A, 104B, and 104C. The device 100 uses the signals received from each of microphones 104A-C to form a beam 106.

The device 100 also includes a presentation module 108 for presenting the user with the device's current beamforming configuration and any information input by the user. In one embodiment, the presentation module 108 also provides a menu of selectable beam steering modes. The presentation module 108 may include any mechanism to present information to the user, including but not limited to, a visual display such as a liquid crystal display (LCD) screen, a speaker, circuitry configured to provide a tactile response, or any combination thereof. For example, in a beam steering mode the presentation module presents to a user the current configuration of the beam 106 such as the beam's shape, direction, and/or strength. The presentation of the beam's current configuration could indicate to a user, for example, whether one or any of the microphones in the array are not receiving signals, such as when a microphone is covered or not operational. The presentation module 108 also presents desired beam configuration data for beam 106 that is input by a user.

The user's desired beam configuration information is input using a user control module 110. The user control module 110 may be any number of input devices such as, for example, a touch-screen display, a keypad, a joystick, microphones, or any combination thereof. Using the user control module 110, a user may input the desired direction for the device's beam 106 such that the beam is steered toward a desired audio source 112. Conversely, by steering the beam 106 toward a desired audio source 112, a user may also steer the beam away from an undesired audio source 114. Thus, the user may receive audio signals 102 while reducing received audio noise 116. The audio sources 112 and 114 can be anything that creates an audio signal. Example situations where multiple audio sources may be present include conference calls with multiple participants in a room, nature sounds such as birds or frogs, interviewing a person in a noisy environment, multiple participants where video is also being recorded, etc. The user control module 110 in combination with feedback presented by the presentation module 108 allows the user to adjust the direction of the beam until the desired direction is achieved. The updated, desired direction may then be saved until the user chooses to alter the beam direction again, or until the device alters the direction in an automatic, device-controlled beamforming mode.

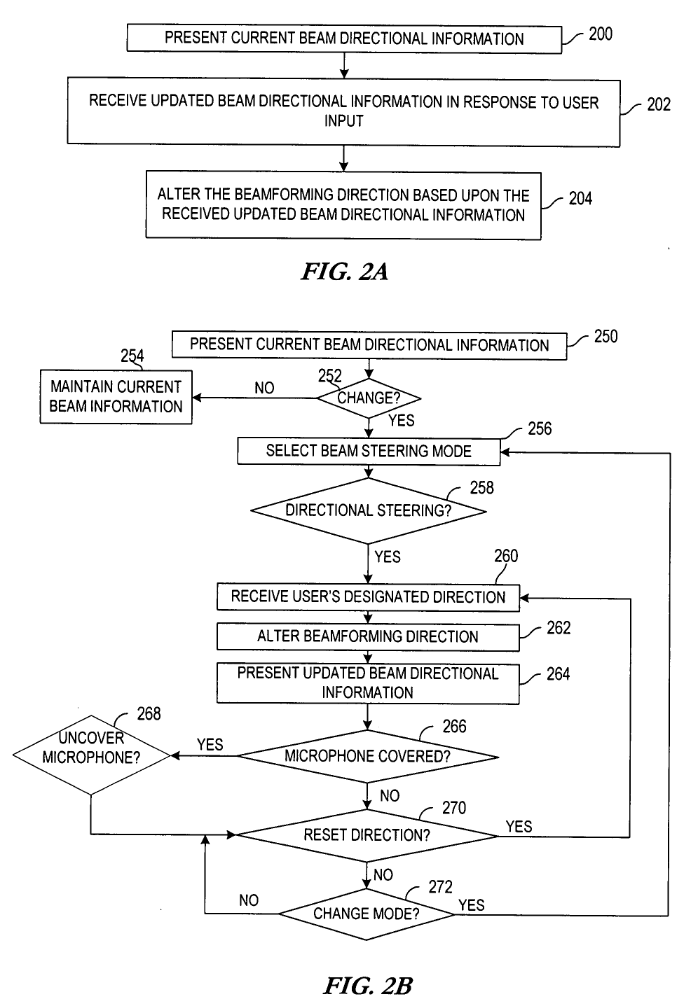

FIG. 2A is a flow diagram illustrating one embodiment of a method for controlling the beamforming of a multiple microphone array in a device in accordance with the present invention. The current beam directional information is presented via a user interface 200. This information can include the direction in which the beam is currently aimed as well as the shape and/or strength of the beam. The shape of the beam is dependent upon the beamforming algorithm used by the beamformer and the number of microphones in the array. The device receives updated beam directional information in response to user input 202. The user may input the updated beam directional information via adjusting a visual representation of the beam's direction shown on the device's display such as moving an arrow, via a voice command, or by moving the device such that an indicator points in the desired direction. In response to receiving the input from the user, the device alters 204 the direction of the beam. Thus, based upon the desired direction of the beam, the device calculates the corresponding filter coefficients to effect the new beam direction.

In another example embodiment, flow diagram FIG. 2B illustrates a method for a user to control the steering of a device's beam. The device presents the current beam directional information to the user 250 so that the user may determine whether the direction should be changed 252. If the user determines that the current settings are acceptable, the beam direction is not changed and the current direction is maintained 254. While the user may determine that the current settings are acceptable, the user may choose to cover one of the microphones of the array to physically alter signal reception by the device. When one or more of the microphones are covered, intentionally or not, the device alerts the user by presenting an alert that one or more of the microphones are covered and which optionally identifies the affected microphones.

If the user decides that the current settings are not acceptable, the user selects a beam steering mode 256. While multiple beam steering modes may be available, example modes may include an omni-directional mode, a beam steering mode, and an automatic beamforming mode. In the omni-directional mode, the device's beam is formed so as to receive signals from all directions equally. In an automatic beamforming mode, the device automatically adjusts the filter coefficients to form a beam in a direction selected by the device. In the beam steering mode, the user inputs desired directional information so as to control the direction in which the beam is steered. Thus, in an omni-directional mode or an automatic beamforming mode, the user's input is not necessary as the device controls the microphone signal reception.

If the user selects a beam steering mode 258, the user inputs the desired directional information 260. The device alters the beam's direction in response to the input directional information 262. The updated directional information reflecting the user's input is presented to the user 264. If the presented updated information indicates that a microphone is covered 266 or otherwise not operational, the user has the opportunity to uncover or repair the microphone's reception status 268. Once the microphone has been uncovered, the microphone status is determined to be acceptable, or if there are no operational problems indicated for the microphone array, the user may evaluate the beam direction and determine whether the direction should be reset 270. If the direction is still not acceptable the user inputs updated directional information 262 and the process repeats. If the direction is acceptable, the user may determine whether a different beam steering mode is appropriate 270. If the current direction and mode are acceptable, the settings are maintained and if the user desires a different beam steering mode, the user selects a new steering mode 256. As would be understood, the user may change the device's beam direction or steering mode at will and the illustrated steps are not to be limited to the order shown.

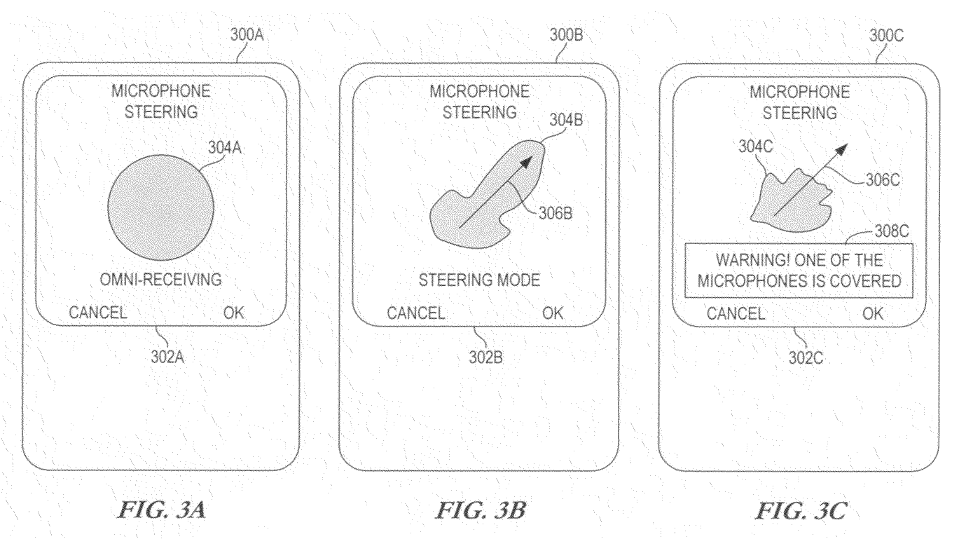

FIGS. 3A-C depict example displays for a device's graphical user interface during user controlled beam steering in accordance with various embodiments of the invention. For example as shown in FIG. 3A, when selecting a steering mode on device 300A, the user may choose an omni-directional steering mode as shown in display 302A. The display screen illustrates that beam 304 is formed in a circular shape indicating that the microphone array is receiving signals from all directions substantially equally.

In another embodiment shown in FIG. 3B, the display 302B of device 300B shows an irregularly shaped beam 304B. The beam 304B corresponds generally with the directional arrow 306B. Directional arrow 306B may be used as an input tool representing the direction in which the beam 306B is formed. For example, the user may adjust the directional arrow 306B to indicate a different, desired direction in which the beam 306B should be formed. The shaded area of beam 304B represents both the shape and direction of beam 304B.

In another embodiment shown in FIG. 3C, the display 302C of device 300C includes a message block 308C. The message block 308C may be used to indicate a situation resulting from the beamforming configuration. For example, in display 302C, while directional arrow 306C is pointing to the upper right corner of the display 302C, the beam 304C does not correspond with the arrow. The message block 308C alerts the user to the cause of the beam 304C and directional arrow 306C discrepancy by indicating that one of the microphones is covered. Using the information provided by the device 300C in message block 308C, the user may address the situation and correct any problems. Thus, while the user controls the beam 304C direction, the device 300C provides guidance and troubleshooting functionality.

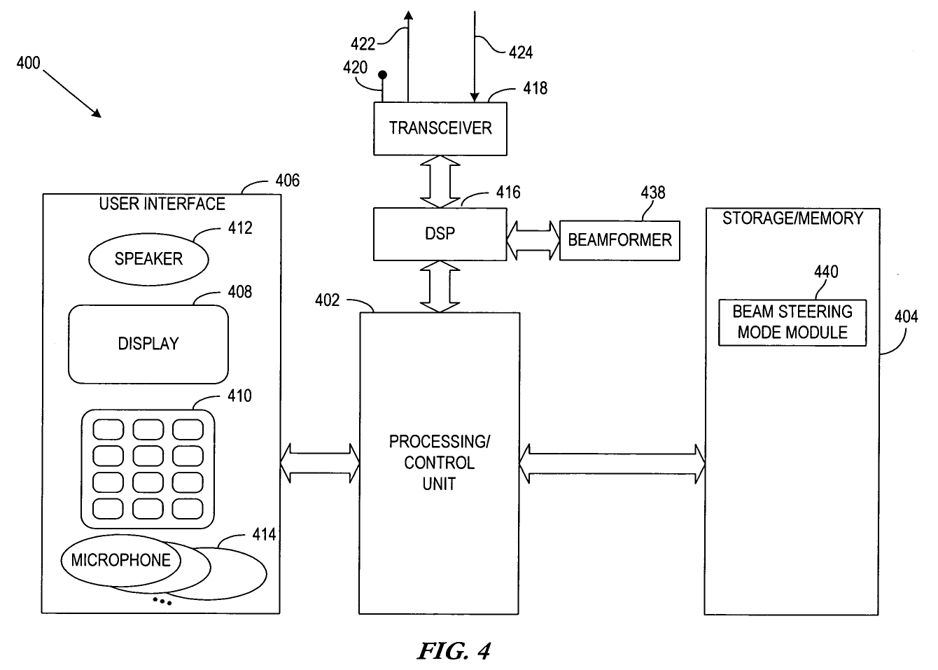

Hardware, firmware, software or a combination thereof may be used to perform the device functions and operations in accordance with the invention. Devices having a microphone array in accordance with the present invention include communication devices such as, for example, mobile phones, PDAs, laptop computers and other wireless communicators, as well as landline computing systems and communicators. A representative example of a mobile device in accordance with the present invention is illustrated in FIG. 4. The mobile device 400 utilizes computing systems to control and manage the conventional device activity as well as the functionality provided by the present invention. The representative mobile device 400 includes a computing system capable of carrying out operations in accordance with the invention. For example, the representative mobile device 400 includes a processing/control unit 402, such as a microprocessor, reduced instruction set computer (RISC), or other central processing module. The processing unit 402 need not be a single device, and may include one or more processors. For example, the processing unit may include a master processor and associated slave processors coupled to communicate with the master processor.

The processing unit 402 controls the basic functions of the mobile device 400 as dictated by programs available in the program storage/memory 404. The storage/memory 404 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the mobile device. The storage 404 may also include one or more of other types of read-only memory (ROM) and programmable and/or erasable ROM, random access memory (RAM), subscriber interface module (SIM), wireless interface module (WIM), smart card, or other fixed or removable memory device. The relevant software for carrying out mobile device operations in accordance with the present invention may also be transmitted to the mobile device 400 via data signals, such as being downloaded electronically via one or more networks, such as the Internet and an intermediate wireless network(s).

For performing other standard mobile device functions, the processor 402 is also coupled to user-interface 406 associated with the mobile device 400. The user-interface (UI) 406 may include, for example, a display 408 such as a liquid crystal display, a keypad 410, speaker 412, and microphones 414. These and other UI components are coupled to the processor 402 as is known in the art. Other UI mechanisms may be employed, such as voice commands, switches, touch pad/screen, graphical user interface using a pointing device, trackball, joystick, or any other user interface mechanism.

The wireless device 400 may also include conventional circuitry for performing wireless transmissions over the mobile network. The DSP 416 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 418, generally coupled to an antenna 420, transmits the outgoing radio signals 422 and receives the incoming radio signals 424 associated with the mobile device 400. For example, signals 422, 424 may be transmitted to a CS network or PS network via a Radio Access Network (RAN), such as provided via GSM.

In the illustrated embodiment, the illustrated device 400 represents an apparatus having a microphone array 414 and a beamformer 438. The storage/memory 404 stores various client programs such as a beam steering program module 440.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
presenting current beam directional information via a user interface;
receiving updated beam directional information in response to user input; and
altering beamforming direction based upon the received updated beam directional information.

2. The method of claim 1, further comprising providing a plurality of selectable modes for beam steering via the user interface.

3. The method of claim 2, wherein one of the selectable modes is an omni-directional receiving mode.

4. The method of claim 2, wherein one of the selectable modes is a directional steering mode.

5. The method of claim 1, wherein presenting current beam directional information includes displaying beam directional information on a graphical user interface.

6. The method of claim 1, wherein presenting current beam directional information includes an audio presentation.

7. The method of claim 1, wherein presenting current beam directional information includes tactile feedback.

8. The method of claim 1, further comprising alerting a user that a microphone is not operational.

9. The method of claim 8, wherein the alert is a visual display of a reduced beam size.

10. An apparatus comprising:
a plurality of microphones;
a user input interface to facilitate user control of a direction of a beam of the plurality of microphones;
a presentation module configured to present current and designated beam directional information of the plurality of microphones; and
a beamformer configured to change the direction of a beam of the plurality of microphones in response to input received from the user input interface.

11. The apparatus of claim 10, wherein the apparatus comprises a mobile device.

12. The apparatus of claim 10, wherein the apparatus comprises at least one of a personal digital assistant, a portable computer, or a video camera.

13. The apparatus of claim 10, wherein the presentation module comprises a visual display.

14. The apparatus of claim 10, wherein the presentation module comprises at least one speaker.

15. The apparatus of claim 10, wherein the presentation module is configured to generate a tactile response representative of at least one of the current and designated beam directional information.

16. The apparatus of claim 10, wherein the user input interface is one of a keyboard, a joystick, a navigational tool, a touch screen, a switch, and a microphone.

17. An apparatus comprising:
means for presenting current beam directional information via a user interface;
means for receiving updated beam directional information in response to user input; and
means for altering beamforming direction based upon the received updated beam directional information.

18. A computer-readable medium having instructions stored thereon which are executable by a processing system for controlling beamforming by performing steps comprising:
presenting current beam directional information via a user interface;
receiving updated beam directional information in response to user input; and
altering beamforming direction based upon the received updated beam directional information.

19. The computer-readable medium of claim 19, wherein altering beamforming direction includes adjusting filter coefficients of a beamformer.

20. A system comprising:
one or more audio sources; and
a device comprising:
a multiple microphone array;
a user input interface to facilitate user control of a direction of a beam of the multiple microphone array relative to one or more of the audio sources;
a presentation module configured to present current and designated beam directional information of the multiple microphone array; and
a beamformer configured to change the direction of a beam of the multiple microphone array in response to input received from the user input interface.
